(19) United States
(12) Patent Application Publication
(10) Pub. No.: US 2006/0187833 A1
(43) Pub. Date: Aug. 24, 2006

(54) Systems and methods for upload bandwidth management

(75) Inventors: Louis J. Montulli, Reno, NV (US); James H. Clark, Redwood City, CA (US); Jeffrey N. Whitehead, San Jose, CA (US); Jason F. Harrison, San Jose, CA (US); Aleksander K. Totic, San Francisco, CA (US); Garrett A. Blythe, Cupertino, CA (US)

Correspondence Address: TRAN & ASSOCIATES, 6768 MEADOW VISTA CT., SAN JOSE, CA, 95135, US

(73) Assignee: Memory Matrix, Inc.

(21) Appl. No.: 11/064,265

(22) Filed: Feb. 23, 2005

(51) Int. Cl. H04L 12/26; H04L 12/28

(52) U.S. Cl. 370/230; 370/252; 370/468; 709/224

(57) ABSTRACT

Systems and methods are disclosed to control an aggregate load from users to a service to improve overall transmission throughput over a network by measuring and monitoring resource utilization for the service, and maintaining additional resource utilization below a predetermined threshold.

### BACKGROUND

The present invention relates generally to network data communications.

Advances in computer technology have provided users with rich content. For example, digital cameras with 5-10 mega-pixel resolutions have appeared. In the video field, HDTV is also becoming accessible for enthusiasts. One result is that the transmission of high resolution data files can bog down even high speed networks. High speed transmission is also needed in network broadcasting where data is transmitted over a network in real time from a single transmitting computer to a plurality of clients simultaneously. The network may be a LAN, a WAN, an intranet or a public network such as the Internet. Network broadcasting is most commonly used to stream multimedia data, typically comprising images and sound.

While a vast amount of fixed bandwidth is allocated for data transfer within the data band, and a small fixed bandwidth is allocated for local communication within the bandwidth spectrum, use of the data band and local band fluctuates in accordance with bandwidth needs associated with the network. Therefore, when data communication from the network to the WAN is minimal, resulting in minimal use of the fixed bandwidth spectrum allocated for such communication, the fixed bandwidth allocated for the data band is essentially wasted.

An example of a situation in which communication from the network to the WAN may be minimal includes, but is not limited to, evening hours when computers within a network may be automatically backing up files over a local area network (LAN), thus requiring additional local band bandwidth and no data band bandwidth. Alternatively, during normal working hours, employees may require additional data band bandwidth for various Internet activities.

Further, since there are bandwidth limitations within both the data band and the local band, increases in local communication traffic slow communication between other local nodes as the fixed bandwidth in the local network becomes totally utilized. In a network with a fixed allocation of bandwidth, the saturation of the Local network will happen regardless of the utilization of the data band spectrum.

U.S. Pat. No. 6,785,296 discloses a system and method for modifying the spectrum allocation for DSL and LAN signals in accordance with bandwidth requirements of a small office, home office (SOHO) network. After initiation of computers within the SOHO network, a handshake procedure is performed between the SOHO network and a wide area network (WAN). The handshake procedure discloses bandwidth requirements for the SOHO network to perform local communication between local area networks (LANs), and for the SOHO network to communicate with the WAN. As a result, the system modifies the spectrum allocation for digital subscriber line (DSL) and LAN signals associated with the SOHO network.

### SUMMARY

In one aspect, systems and methods are disclosed to control an aggregate load from users to a service to improve overall transmission throughput over a network by measuring and monitoring resource utilization for the service, and maintaining additional resource utilization below a predetermined threshold.

In another aspect, systems and methods are disclosed for managing transmission bandwidth by identifying a maximum transmission bandwidth for a network; determining whether an upload transmission rate is equal to the maximum transmission bandwidth; and reducing the upload transmission rate to a predetermined level below the maximum transmission bandwidth.

Advantages of the system may include one or more of the following. The network can dynamically allocate bandwidth as necessary based on the transmission data requirement. The bandwidth for uploads is managed to avoid hogging all transmission bandwidth and resulting in sub-optimal use of the network. The process is applicable to ADSL broadband residential network connections which have more downstream bandwidth than upstream. The system avoids the situation where if a transfer uses all the available upstream bandwidth to transfer data, the downstream bandwidth becomes almost unusable because packet acknowledgments are not able to be quickly sent back to the sender. This is achieved by keeping upload bandwidth usage to a level where they use most but not all of the available upstream bandwidth. In that case, the downstream bandwidth is still usable because there is still space for acknowledgments to be sent on the upstream.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a flow chart illustrating a first bandwidth management process.

FIG. 2 is a flow chart illustrating a second bandwidth management process.

FIG. 3 is a flow chart illustrating a third bandwidth management process.

FIG. 4 illustrates an exemplary environment running a bandwidth reservation protocol.

### DESCRIPTION

FIG. 1 shows a first embodiment of a process to control an aggregate load from users to a service to improve overall transmission throughput over a network. The process measures and monitors resource utilization for the service (2). The process then maintains additional resource utilization below a predetermined threshold (4). The protocol for measuring and monitoring resource utilization, and then assuring that additional resource utilization does not exceed a given threshold controls the aggregate load from all users to a given service to improve overall transmission throughput. In one application, the system uses a metric, such as megabytes/second, or disk operations a second on a busy file server, to deliver better quality of service without adding additional resources.

The system operates at the application level, as opposed to the network level. The protocol does not require compatibility end-to-end between the client and the server. The protocols generally attempt to reserve an amount of bandwidth for immediate usage, and do not attempt to ascertain the best time to perform a given operation. In one implementation of the protocol, the system works with both clients which do not adhere to the protocol (ie, their usage is measured, but not controlled), as well as participating clients (whos usage is both measured as well as controlled). This lends itself to applications where there could be different pricing structures. The protocol can allocate excess free (ie, otherwise unused) capacity to certain customers,” and in that sense offers beneficial pricing. The benefits are achieved without dropping communications packets at an asymptotically greater rate as a communications pipe approaches its bandwidth-avoiding delays and retransmissions. Thus, the system provides better control in selecting certain users to reduce bandwidth requirement on to achieve application level bandwidth allocation.

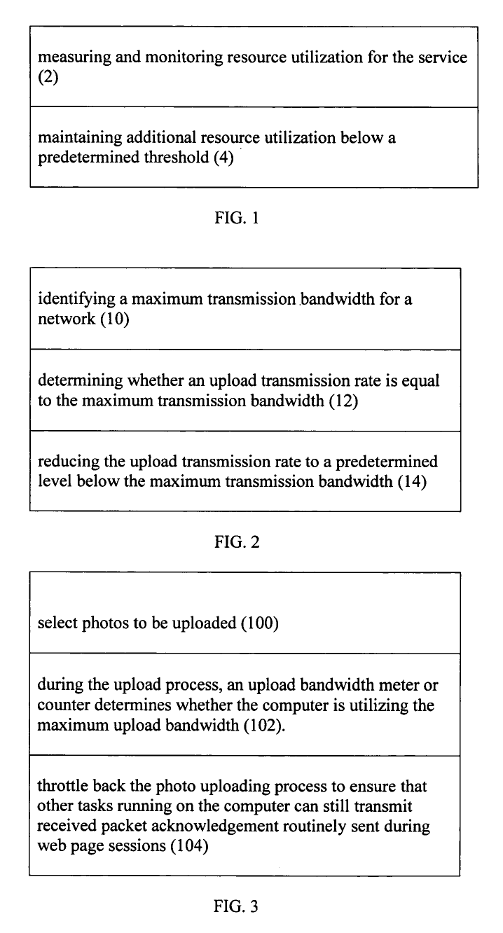

FIG. 2 shows an exemplary bandwidth management process. The process of FIG. 1 handles data transmission over a broadband network such as ADSL, among others. The process identifies a maximum transmission bandwidth for a network (10). Next, it determines whether an upload transmission rate is equal to the maximum transmission bandwidth (12), and if so, the process reduces or throttles down the upload transmission rate to a predetermined level below the maximum transmission bandwidth (14).

The maximum transmission bandwidth comprises a maximum upload bandwidth. The data can be transmitted or received over an xDSL line such as an ADSL line. In ADSL broadband residential network connections, typically the downstream bandwidth is higher than the upstream bandwidth. The reducing the upload transmission rate can include providing sufficient bandwidth to transmit received packet acknowledgments over the ADSL line.

The bandwidth management process of FIG. 2 ensures that uploading processes do not hog the broadband connection. The process uploads data to a server while not using all available bandwidth. If a transfer uses all the available upstream bandwidth to transfer data, the downstream bandwidth becomes almost unusable because packet acknowledgments are not able to be quickly sent back to the sender. If uploads are kept to a level where they use most but not all of the available upstream bandwidth the downstream bandwidth is still usable because there is still space for acknowledgments to be sent upstream.

In one implementation, the bandwidth meter measures the information-carrying capacity, or bandwidth, between the client and a test server. In one case, to monitor download bandwidth, the client is the user, and the server is the test server. Once the meter is started, the Meter downloads a predetermined file such as an image to the user's computer. The image size will vary—50K, 150K, 500K, or 1.5MB—and is determined by the connection speed. The amount of time it takes for that file to be completely downloaded corresponds to the user's broadband download bandwidth. In another case where the meter measures upload bandwidth, the meter counts the amount of data transmitted over a predetermined interval, such as a second. The result of the count is the upload bandwidth (per second).

In one implementation, the process runs on a home or small office computer network with communication between a central office and a customer premise by way of a local loop. While the customer premise may be a single dwelling residence, a small business, or other entity, it is generally characterized as having a computer and POTS equipment, such as a telephone, PSTN modem or fax machine. Particular to the preferred embodiment of the invention, the customer premise is a SOHO network comprising a number of computers that are logically connected, and the central office is located within a WAN. The customer premise may also include an ADSL communication device, such as an ADSL modem. At the central office, additional circuitry is provided. Generally, a line card containing line interface circuitry is provided for electrical connection to the local loop. For example, an ADSL interface card may also be provided at the central office in order to handle ADSL services.

FIG. 3 illustrates an exemplary use of the bandwidth management process in a photo uploading environment. First, the user selects photos to be uploaded (100). This can be done by Choosing Photos as follows: Click the orange Choose Photos button at the top of the page; navigate through computer's file system and open the folder that contains photos; and click the Open button when finished selecting your photos. In another process for choosing photos, the user can Drag and Drop the photos as follows: navigate through the computer's file system and open the folder that contains photos in a new window; use mouse button down to pick up a selected List of photos, drag them over to the gray Drag and Drop area of the Upload page, and release the mouse button. To select a plurality of photos, the user can hold the left mouse button down while dragging the mouse over the desired photos; hold down the Shift key while single-clicking the first, then the last file in a List to select every file in-between.; or hold down the Ctrl key while single-clicking files that are not next to each other in the folder. In one example, the user clicks on an Add Photos tab and creates a name for a photo-album. The user browses the photos he/she wants to upload or just drag and drop them into a Photo-Upload window. The user can click on a Start Upload button and watches the photos appear in the new album.

During the upload process, an upload bandwidth meter or counter determines whether the computer is utilizing the maximum upload bandwidth (102). If the upload consumption exceeds a predetermined threshold (such as 95% of upload bandwidth), the computer throttles back the photo uploading process to ensure that other tasks running on the computer can still transmit received packet acknowledgement routinely sent during web page sessions (104). In this manner, the uploading process can proceed at a rapid pace without holding up other processes that may be downloading pages over the Internet.

In another embodiment, instead of having a fixed predetermined threshold, the process can have a variable threshold, namely that the process throttles back the upload transmission just enough so that the received packet acknowledgement can be transmitted, and then returns the full upload bandwidth to the uploading process.

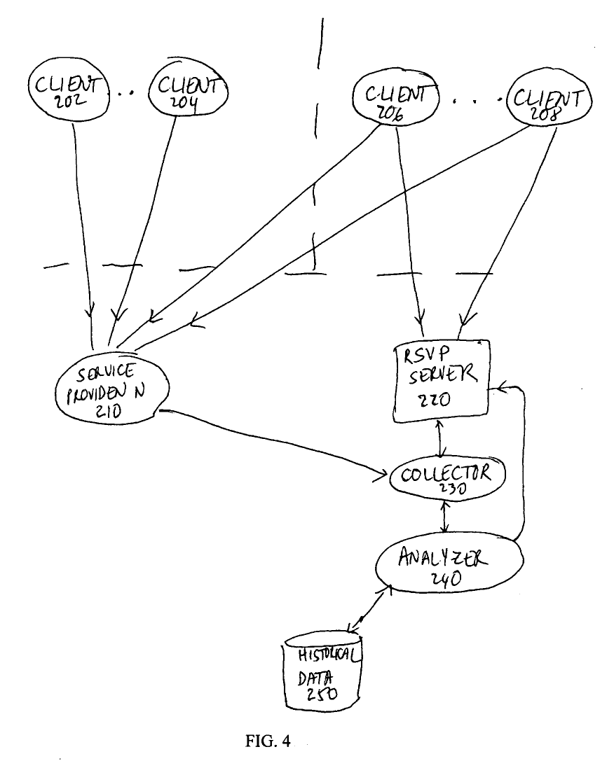

FIG. 4 illustrates an exemplary environment running a bandwidth reservation protocol. In this environment, a plurality of clients 202-208 communicate with one or more service providers 210. Clients 202-204 are not participating in the bandwidth management process, while clients 206-208 are participating in the bandwidth management process using the bandwidth reservation protocol. Participating clients 206-208 also communicate with an RSVP server 220. The server 220 communicates with a bandwidth data collector 230, which in turn receives data from the service provider 210. The collector 230 in turn communicates with an analyzer 240. The analyzer 240 in turn consults with a historical database 250 and communicates with the server 220 how much bandwidth or load to allocate.

The bandwidth reservation RSVP protocol smooth out the usage curve (ie, take advantage of the drop in traffic at night for “free” uploads and charge for use during peak periods). The protocol ensures that revenue generating events take priority, while giving fair bandwidth allocations to all users. The RSVP protocol is an advisory protocol, which means that clients must explicitly choose to support it. Those ignoring the protocol will continue to work as they do today. Prior to conducting any bandwidth intensive operations (such as uploading images), under one scenario, an RSVP must be requested. A client submits a request for authorization for a specified speed, and its expected duration of the transaction. The client receives in response a time slot and a maximum bit-rate for the transaction, which may be less than the bit rate that it requested.

An exemplary implementation with a simple transaction via HTTP request can be as follows:

http://rsvp.memorymatrix.com.com/getReservation.cgi?AuthenticationId=<token>&MySpeed=<Bps>

&TransactionType=<enum>&RSVPDuration=<secs>&Direction=<up/down>
where myspeed is the expected bps to be utilized by the client. It is calculated and stored by the client (as described in the other portion of the claim),
rsvpduration is how long the client expects to use the connection at the aforementioned bitrate (calculated from the file size)
transaction_type is an identifier, which allows us to establish priorities. The priority types can include purchase_upload, sync, download and upload, for example.

A response can be as follows:

<token>—RSVP ID

<RSVP begin>—Timestamp

<Bitrate>—rate in kb/sec

<polling interval>—interval by which to perform polling

A second interface can also exist, and should be polled when the client is idling waiting for its upload slot to become available as follows:

http://rsvp.shutterfly.com/checkReservation.cgi?token=<token>

A response will look like

<token>—RSVP ID

<RSVP begin>—Timestamp

<Bitrate>—rate in kb/sec

This second poll exists because we may be able to start uploading sooner then expected; the RSVP is for the _latest possible_time. The polling interval is the interval returned by the first request, plus a random portion of 25% of the interval, ie, interval=poll_interval+(poll_interval*0.25*random_float_between_{—}0_and_{—}1). If the RSVP server is not reachable, but the rest of the service is, the client should have some coded in defaults (for example only start uploading after 10:00 PM).

In order to accomplish the smoothing of the usage curve, the server 220 needs to have access to outbound routers (via SNMP) or other load metric so that it can measure the current bandwidth of those not participating in the advisory scheme. The server ensures that the client usage does not cause bandwidth to exceed an expected peak, or that after a daily peak has been established, the bandwidth does not exceed 95% of peak. The server can operate with a granularity greater than a 1 minute interval.

Pseudo code for one implementation is as follows:
Determine expected peak time from week over week data
Determine expected peak value from todays traffic data
If time<expected peak time, then traffic allowed for RSVP is 0.75 of delta between expected peak and current.
If time>expected peak time, then traffic allowed for RSVP is the delta between observed peak and current The server will also provide for the ability to schedule downtime/maintenance, among others. The server is also adaptable to varying load metrics, based on actual need. The bandwidth management system of the present invention can be implemented in software, firmware, hardware, or a combination thereof. In the preferred embodiment of the invention, which is intended to be a non-limiting example, the system is implemented in software that is executed by a computer, for example, but not limited to, a personal computer, work station, mini computer, or mainframe computer.

The software-based system, which comprises an ordered listing of executable instructions for implementing logical functions, can be embodied in any computer-readable medium for use by, or in connection with, an instruction execution system, apparatus, or device such as a computer-based system processor-containing system, or other system that can fetch the instructions from the instruction execution system, apparatus, or device and execute the instructions. In the context of this document, a “computer-readable medium” can be any means that can contain, store, communicate, propagate or transport the program for use by or in connection with the instruction execution system, apparatus or device. The computer-readable medium can be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disk read-only memory (CD ROM) (optical). Note that the computer-readable medium could even be paper or another suitable medium upon which the program is printed, as the program can be electronically captured, via for instance, optical scanning of the paper or other medium, then compiled, interpreted or otherwise processed in a suitable manner, if necessary, and then stored in a computer memory.

What is claimed is:

1. A process to control an aggregate load from users to a service to improve overall transmission throughput over a network, comprising:
measuring and monitoring resource utilization for the service, and
maintaining additional resource utilization below a predetermined threshold.

2. The process of claim 1, comprising:
identifying a maximum transmission bandwidth for the network;
determining whether an upload transmission rate is equal to the maximum transmission bandwidth; and
reducing the upload transmission rate to a predetermined level below the maximum transmission bandwidth.

3. The process of claim 2, wherein the maximum transmission bandwidth comprises a maximum upload bandwidth.

4. The process of claim 1, comprising transceiving data over a DSL line or an ADSL line.

5. The process of claim 1, comprising transmitting packet acknowledgments over the network.

6. The process of claim 1, comprising providing sufficient bandwidth to transmit received packet acknowledgments over the network.

7. The process of claim 1, comprising applying a metric to deliver better quality of service without adding additional resources.

8. The process of claim 7, wherein the metric comprises one of: transmission rate and disk operation rate on a file server.

9. A system to control an aggregate load from users to a service to improve overall transmission throughput over a network, comprising:
means for measuring and monitoring resource utilization for the service, and
means for maintaining additional resource utilization below a predetermined threshold.

10. The system of claim 9, comprising:
means for identifying a maximum transmission bandwidth for a network;
means for determining whether an upload transmission rate is equal to the maximum transmission bandwidth; and
means for reducing the upload transmission rate to a predetermined level below the maximum transmission bandwidth.

11. The system of claim 9, wherein the maximum transmission bandwidth comprises a maximum upload bandwidth.

12. The system of claim 9, comprising means for transceiving data over an xDSL line.

13. The system of claim -12, comprising means for transmitting packet acknowledgments over the xDSL line.

14. The system of claim 9, wherein the means for reducing the upload transmission rate comprises a means for providing sufficient bandwidth to transmit received packet acknowledgments over the ADSL line.

15. A system for data transmission, comprising:
a data structure to identify a maximum transmission bandwidth for a network;
an upload bandwidth counter;
a comparator coupled to the data structure and upload bandwidth counter to determine whether an upload transmission rate is equal to the maximum transmission bandwidth; and
a processor coupled to the comparator, the processor reducing the upload transmission rate to a predetermined level below the maximum transmission bandwidth.

16. The system of claim 15, wherein the maximum transmission bandwidth comprises a maximum upload bandwidth.

17. The system of claim 15, comprising a modem transceiver coupled to an xDSL line.

18. The system of claim 15, comprising means for transmitting packet acknowledgments over the xDSL line.

19. The system of claim 15, comprising means for applying a metric to deliver better quality of service without adding additional resources.

20. The system of claim 19, wherein the metric comprises one of: transmission rate and disk operation rate on a file server.
